(19) United States
(12) Patent Application Publication
(10) Pub. No.: US 2004/0013914 A1
(43) Pub. Date: Jan. 22, 2004

(54) Method for assembling atoms and molecules

(76) Inventor: Judd McManus, Higganum, CT (US)

Correspondence Address: Judd McManus, 280 Hidden Lake Rd, Higganum, CT, 06441, US

(21) Appl. No.: 10/198,661

(22) Filed: Jul. 16, 2002

(51) Int. Cl. H01M 8/00; H01M 8/10

(52) U.S. Cl. 429/13; 429/17; 429/30

(57) ABSTRACT

A method for assembling atoms and molecules from subatomic particles is presented. This invention also relates to the recycling of atoms and molecules in the context of fuel cell systems.

The benefits of assembling atoms and molecules from subatomic particles are immense. With proper control over the assembly of atoms and molecules from subatomic particles, many of the world's energy problems can be solved. The possibilities for a system that can assemble atoms and molecules using a practical, safe, and low-cost method are enormous.

In the energy area alone, if we had the ability to assemble atoms from subatomic particles, we could use an atom such as hydrogen in a fuel cell system and then recycle the hydrogen atom for further use.

Through the invented method, atoms and molecules can now be assembled from subatomic particles using a practical, safe, and low-cost method. By following the steps of the invented method we can now recycle atoms and molecules in fuel cell systems.

### BACKGROUND OF THE INVENTION

This invention relates to the assembly of atoms and molecules from subatomic particles. This invention also relates to the recycling of atoms and molecules in the context of fuel cell systems.

The benefits of assembling atoms and molecules from subatomic particles are immense. With proper control over the assembly of atoms and molecules from subatomic particles, many of the world's energy problems can be solved. The possibilities for a system that can assemble atoms and molecules using a practical, safe, and low-cost method are enormous.

In the energy area alone, if we had the ability to assemble atoms from subatomic particles, we could use an atom such as hydrogen in a fuel cell system and then recycle the hydrogen atom for further use.

In my earlier patent application (10/157,675 filed on May 29, 2002) I demonstrate a method for transferring hydrogen gas in PEM fuel cell systems and assembling hydrogen atoms. With my new invention, I have made a number of important changes to the configuration.

Accordingly, it is an object of this invention to provide a new method for assembling atoms and molecules. Furthermore, it is an object of this invention to provide for the key series of steps needed to recycle atoms and molecules in fuel cell systems.

Through the invented method, atoms and molecules can now be assembled from subatomic particles using a practical, safe, and low-cost method. By following the steps of the invented method we can now recycle atoms and molecules in fuel cell systems.

### BRIEF SUMMARY OF THE INVENTION

The invented method for assembling atoms and molecules from subatomic particles is configured to include hydrogen gas, a fuel cell system, transport piping, and pressure.

The transport piping is filled with hydrogen gas. One side of the transport piping is configured to be longer than the other. Hydrogen gas is supplied to the fuel cell system. As hydrogen molecules come into contact with the platinum coating on the proton conductive membrane of the fuel cell system, molecules separate into single atoms. The membrane assists in separating the hydrogen atoms into protons and electrons by allowing the protons to pass through the membrane and blocking the electrons. Sufficient pressure is used to assist in forcing the protons through the membrane. Electrons are able to travel through an external electrical circuit where they can be used to perform work. The protons and free electrons end up on the same side of the membrane. The configuration of the transport piping provides proper conditions to prevent the protons and free electrons from reacting with any other substance; the protons and free electrons are now able to combine to form hydrogen atoms. The configuration of the transport piping provides proper conditions to prevent the hydrogen atoms from reacting with any other substance; the hydrogen atoms are now able to form hydrogen molecules, thus recycling hydrogen for further use.

### BRIEF DESCRIPTION OF DRAWING

FIG. 1 Sample configuration to perform the invented method

### DETAILED DESCRIPTION OF THE INVENTION

The invented method for assembling atoms and molecules from subatomic particles is configured to include hydrogen gas, a fuel cell system, transport piping, and pressure.

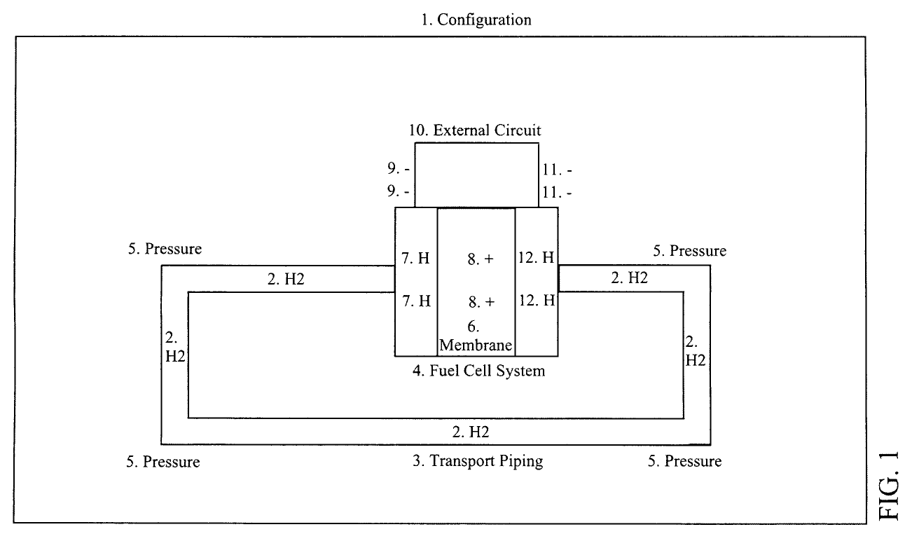

FIG. 1 shows a sample configuration (1) containing hydrogen gas (2), transport piping (3), a fuel cell system (4), and pressure (5).

To replicate the invented method we set up the configuration (1) as shown in FIG. 1. One side of the transport piping (3) is configured to be longer than the other. With the setup complete, hydrogen gas (2) is supplied to the fuel cell system (4) by using pressure (5).

As hydrogen gas/molecules (2) come into contact with the platinum coating on the proton conductive membrane (6) of the fuel cell system (4), molecules (2) separate into single atoms (7). The membrane (6) assists in separating the hydrogen atoms (7) into protons (8) and electrons (9) by allowing the protons (8) to pass through the membrane (6) and blocking the electrons (9). Sufficient pressure (5) is used to assist in forcing the protons (8) through the membrane (6). Electrons (9) are able to travel through an external electrical circuit (10) where they can be used to perform work. The protons (8) and free electrons ( 11) end up on the same side of the membrane. The configuration of the transport piping (3) provides proper conditions to prevent the protons (8) and free electrons (11) from reacting with any other substance; the protons (8) and free electrons (11) are now able to combine to form hydrogen atoms (12). The configuration of the transport piping (3) provides proper conditions to prevent the hydrogen atoms (12) from reacting with any other substance; the hydrogen atoms (12) are now able to form hydrogen molecules (2), thus recycling hydrogen (2) for further use.

By following the steps of the invented method and setting up the configuration (1) as shown in FIG. 1, we are now able to assemble atoms (12) and molecules (2) from subatomic particles (8/11). By following the steps of the invented method we are now able to recycle atoms (7/12) and molecules (2) in fuel cell systems (4).

As demonstrated in FIG. 1 we are now able to assemble an atom (12) using subatomic particles (8/11) by having subatomic particles (8/11) available and by providing for proper conditions (3/5) so that subatomic particles (8/11) may combine to form an atom (12). As shown, we are able to derive subatomic particles (8/9/11) from an atom (7). Using our current configuration, we are able to assemble an atom (12) that is atomically equivalent to the atom (7) from which the subatomic particles (8/9/11) were derived. We can now recycle the assembled atom (12) for further use. In FIG. 1, subatomic particles (8/9/11) are derived from hydrogen (7), the assembled atom (12) is hydrogen, and the subatomic particles (8/9/11) are used in the fuel cell system (4).

As demonstrated in FIG. 1 we are now able to assemble a molecule (2) using subatomic particles (8/11) by having subatomic particles (8/11) available and by providing for proper conditions (3/5) so that subatomic particles (8/11) may combine to form atoms (12), and atoms (12) may combine to form a molecule (2). As shown, we are able to derive subatomic particles (8/9/11) from a molecule (2). Using our current configuration, we are able to assemble a molecule (2) that is molecularly equivalent to the molecule (2) from which the subatomic particles (8/9/11) were derived. We can now recycle the assembled molecule (2) for further use. In FIG. 1, subatomic particles (8/9/11) are derived from hydrogen (2), the assembled atom (12) is hydrogen, the assembled molecule is hydrogen (2), and the subatomic particles (8/9/11) are used in the fuel cell system (4).

Although the above description contains many specifics, these should not be construed as limiting the scope of the invention, but as providing illustrations of some of the presently preferred embodiments of this invention.

Thus the scope of the invention should be determined by the appended claims and their legal equivalents, rather than by the example given.

I claim:

1. Method for assembling atom, comprising subatomic particles, providing for proper conditions so that subatomic particles may combine to form atom, whereby atom can be assembled from subatomic particles.

2. Method for assembling atom, comprising the steps of claim 1 where subatomic particles are derived from atom.

3. Method for assembling atom, comprising the steps of claim 1 where assembled atom is atomically equivalent to atom from which subatomic particles were derived.

4. Method for assembling atom, comprising the steps of claim 1 where assembled atom is recycled for further use.

5. Method for assembling atom, comprising the steps of claim 1 where subatomic particles are derived from hydrogen.

6. Method for assembling atom, comprising the steps of claim 1 where assembled atom is hydrogen.

7. Method for assembling atom, comprising the steps of claim 1 where subatomic particles are used in fuel cell system.

8. Method for assembling molecule, comprising subatomic particles, providing for proper conditions so that subatomic particles may combine to form atoms, providing for proper conditions so that atoms may combine to form molecule, whereby molecule can be assembled from subatomic particles.

9. Method for assembling molecule, comprising the steps of claim 8 where subatomic particles are derived from molecule.

10. Method for assembling molecule, comprising the steps of claim 8 where assembled molecule is molecularly equivalent to molecule from which subatomic particles were derived.

11. Method for assembling molecule, comprising the steps of claim 8 where assembled molecule is recycled for further use.

12. Method for assembling molecule, comprising the steps of claim 8 where subatomic particles are derived from hydrogen.

13. Method for assembling molecule, comprising the steps of claim 8 where assembled molecule is hydrogen (H2).

14. Method for assembling molecule, comprising the steps of claim 8 where subatomic particles are used in fuel cell system.

15. Method for recycling hydrogen atom in fuel cell system, comprising hydrogen atom, separating hydrogen atom into proton and electron, proton passing through proton conductive membrane of fuel cell system, free electron traveling through external circuit of fuel cell system, proton and free electron combining to form hydrogen atom, whereby hydrogen atom can be used for useful purpose in fuel cell system and recycled for further use.

16. Method for recycling hydrogen molecule in fuel cell system, comprising hydrogen molecule, separating hydrogen molecule into hydrogen atoms, separating hydrogen atoms into protons and electrons, protons passing through proton conductive membrane of fuel cell system, free electrons traveling through external circuit of fuel cell system, protons and free electrons combining to form hydrogen atoms, hydrogen atoms combining to form hydrogen molecule, whereby hydrogen molecule can be used for useful purpose in fuel cell system and recycled for further use.
